(19) United States
(12) Patent Application Publication
(10) Pub. No.: US 2007/0189032 A1
(43) Pub. Date: Aug. 16, 2007

(54) Backlight system

(75) Inventor: Shao-Han Chang, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/508,541

(22) Filed: Aug. 23, 2006

(30) Foreign Application Priority Data
Feb. 10, 2006 (CN) 200610033577.8

(51) Int. Cl. F21V 7/04

(52) U.S. Cl. 362/600

(57) ABSTRACT

A backlight system includes a light diffusion plate and at least one light source module. The light source module is disposed under the light diffusion plate. The light source module includes a base, a sidewall extending from a longitudinal edge of the base, a protrusion formed on an edge of the base opposite the first sidewall, the protrusion having a reflective surface facing the sidewall, and at least a light source fixed on an inner surface of the sidewall facing the reflective surface of the protrusion. Light rays from the light source being reflected at the reflective surface toward the light diffusion plate. The present backlight system has a good optical performance, lightweight and thin body.

### CROSS-REFERENCE TO RELATED APPLICATIONS

This application is related to co-pending U.S. patent applications, entitled “LIGHT SOURCE MODULE AND BACKLIGHT SYSTEM USING THE SAME”, by Shao-Han Chang and Fen Chen with Attorney Docket No. 14963-56245; entitled “BACKLIGHT MODULE”, by Shao-Han Chang with Attorney Docket No. 14963-56247; entitled “DIRECT TYPE BACKLIGHT MODULE”, by Shao-Han Chang with Attorney Docket No. 14963-56244. Such applications have the same assignee as the present application and have been concurrently filed herewith. The disclosure of the above identified applications is incorporated herein by reference.

### TECHNICAL FIELD

The present invention relates to backlight systems, more particularly, to a hollow reflective backlight system for use in, for example, a liquid crystal display (LCD).

### BACKGROUND

Most liquid crystal display devices are passive devices in which images are displayed by controlling an amount of light input from an outside light source. Thus, a separate light source (for example, backlight system) is generally employed for illuminating an LCD.

Generally, backlight systems can be classified into an edge lighting type or a bottom lighting type based upon the location of lamps within the devices. The edge lighting type backlight system has a lamp unit arranged at a side portion of a light guiding plate for guiding light. The edge lighting type backlight systems are commonly employed in small-sized LCD due to their lightweight, small size, and low electricity consumption. However, the edge lighting type backlight system has a relative low optical brightness. A bottom lighting type backlight system has a plurality of lamps arranged in regular positions to directly illuminate an entire surface of an LCD panel. The bottom lighting type backlight systems have higher efficiency of light usage than the edge lighting type backlight systems. However, the bottom lighting type backlight system has a relative low illuminance uniformity.

In order to overcome the above mentioned shortcomings, a hollow type backlight system is provided. Referring to FIG. 7, a typical hollow backlight system 10 includes a first light guide plate 11, a second light guide plate 12, two light sources 13, a reflecting plate 14, and a diffusing film 15. The first light guide plate 11 includes a first inner surface 111 and a first outer surface 112. The second light guide plate 12 includes a second inner surface 121 and a second outer surface 122. The first and second inner surfaces 111 and 121 are inner concave curvature surfaces. The second light guide plate 12 and the first light guide plate 11 cooperatively forms a hollow light-guiding zone 16 therebetween.

The two light sources 13 are located at two sides of the hollow light-guiding zone 16. Each light source 13 includes a plurality of lamp tubes 131 and a reflector 132. Light from the two light sources 13 scatters into the hollow light-guiding zone 16 and enters the first and the second light guide plates 11 and 12 via the first and the second inner surfaces 111 and 121. The reflecting plate 14 is located adjacent the second outer surface 122 of the second light guide plate 12 to immediately reflect the light emitting out of the second outer surface 122 to reenter the second light guide plate 12 and back into the hollow light-guiding zone 16. The diffusing film 15 is located on the first outer surface 112 of the first light guide plate 11 for diffusing the light emitting out of the first outer surface 112 thus, producing uniform light output.

Typically, if light sources positioned directly under optical sheets may result in dark strips caused by the reduced intensity of light between adjacent light sources. This configuration of the backlight system 10 avoids light sources 13 being positioned directly under the first light guide plate 11, so as to attain a relative good optical uniformity.

However, the backlight system 10 increases cost of materials due to an employment of two light guide plates 11 and 12, further increasing its weight. In addition, because the first and second light guide plate 11 and 12 are usually formed of transparent synthetic resin material, such as polymethyl methacrylate (PMMA) and polycarbonate (PC), the first and second light guide plates 11 and 12 have thermal deformation and deflection problems after absorbing a great deal of heat energy produced by the lamp tubes 131, furthermore, the first and the second light guide plates 11 and 12 may change color due to long-term irradiation by the lamp tubes 131. This would shorten a service life of the backlight system of the LCD. Furthermore, a design of the backlight system 10 has a significant large thickness due to the hollow light-guiding zone 16 property between the first and second light guide plate 11 and 12.

What is needed, therefore, is a backlight system that overcomes the above mentioned shortcomings.

### SUMMARY

A backlight system according to a preferred embodiment includes a light diffusion plate and at least one light source module. The light source module is disposed under the light diffusion plate. The light source module includes a base, a sidewall extending from a longitudinal edge of the base, a protrusion formed on an edge of the base opposite the first sidewall, the protrusion having a reflective surface facing the sidewall, and at least a light source fixed on or adjacent to an inner surface of the sidewall facing the reflective surface of the protrusion in a manner so as to allow light rays from the light source to be reflected at the reflective surface toward the light diffusion plate.

Other advantages and novel features will become more apparent from the following detailed description of the preferred embodiments, when taken in conjunction with the accompanying drawings.

### BRIEF DESCRIPTION OF THE DRAWINGS

Many aspects of the present backlight system can be better understood with reference to the following drawings. The components in the drawings are not necessarily drawn to scale, the emphasis instead being placed upon clearly illustrating the principles of the present backlight system. Moreover, in the drawings, like reference numerals designate corresponding parts throughout the several views.

FIG. 1 is a schematic, cross-sectional view of a backlight system according to a first preferred embodiment;

FIG. 2 is a schematic, cross-sectional view of a backlight system according to a second preferred embodiment;

FIG. 3 is a schematic, cross-sectional view of a backlight system according to a third preferred embodiment;

FIG. 4 is a schematic, cross-sectional view of a backlight system according to a fourth preferred embodiment;

FIG. 5 is a schematic, cross-sectional view of a backlight system according to a fifth preferred embodiment;

FIG. 6 is a schematic, cross-sectional view of a backlight system according to a sixth preferred embodiment; and

FIG. 7 is a schematic, cross-sectional view of a conventional backlight system.

### DETAILED DESCRIPTION OF THE PREFERRED EMBODIMENTS

Reference will now be made to the drawings to describe preferred embodiments of the present backlight system, in detail.

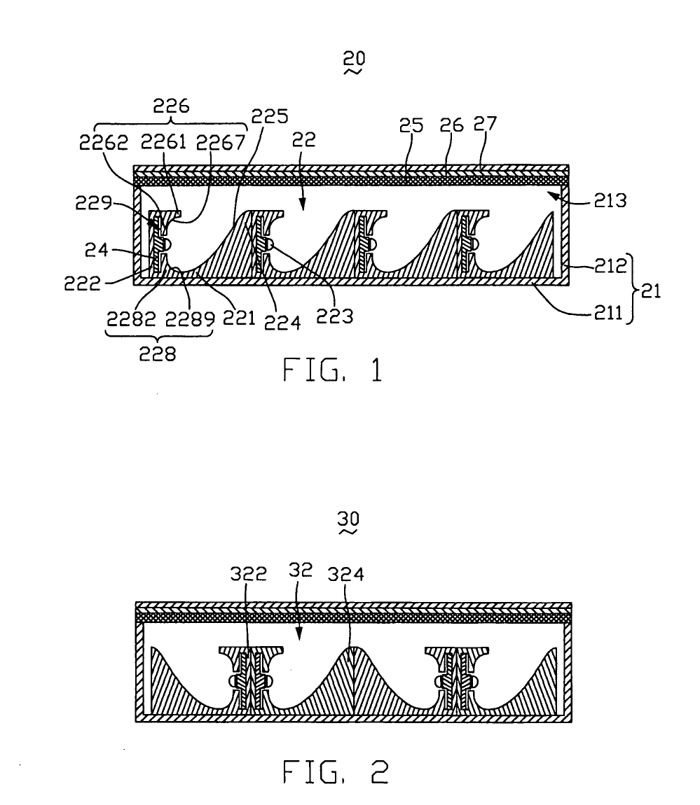

Referring to FIG. 1, a backlight system 20 in accordance with a first preferred embodiment is shown. The backlight system 20 includes a frame 21, a plurality of light source modules 22, and a light diffusion plate 25. The frame 21 includes a rectangular substrate 211, four second sidewalls 212 extending from the peripheral of the substrate 211 to define an opening 213. The light diffusion plate 25 is disposed on the opening 213 of the frame 21. The light source modules 22 are aligned side by side on the substrate 211 of the frame 21, beneath the light diffusion plate 25.

Each light source module 22 includes a base 221, a first sidewall 222 extending out from a first longitudinal edge of the base 221, a protrusion 224 extending out from a second longitudinal edge of the base 221 opposite the first longitudinal edge, the protrusion 224 having a first reflective surface 225 facing the first sidewall 222, and at least a light source 223 fixed on an inner surface of the first sidewall 222 facing the first reflective surface 225 of the protrusion 224. In this embodiment, the first reflective surface 225 is a curved surface.

In order to improve light energy utilization rate, each light source module 22 further includes an upper reflective unit 226 positioned on a top of the first sidewall 222. In this embodiment, each upper reflective unit 226 includes a first protruding portion 2261 extending perpendicularly from a top the first sidewall 222 towards an inner area of the base 221 and a second protruding portion 2262 extending from an interior portion of the first protruding portion 2261 towards the base 221. The first protruding portion 2261 and the second protruding portion 2262 cooperatively forming a second reflective surface 2267 that is a concave surface between two exposing longitudinal edge of the first protruding portion 2261 and the second protruding portion 2262 facing the reflective surface 225. The second reflective surface 2267 is a curved surface. Light rays from the light sources 223 projected at the second reflective surface 2267 are reflected toward the first reflective surface 225, and finally reflected again into the light diffusion plate 25.

In the same way, each light source module 22 further includes a bottom reflective unit 228 each positioned on the base 211 adjacent to the first sidewall 222. In this embodiment, each bottom reflective unit 228 includes a third protruding portion 2282 extending from the base 221 toward the light diffusion plate 25, the third protruding portion 2282 and the base 221 cooperatively forming a third reflective surface 2287 interconnecting the first reflective surface 225. The third reflective surface 2287 is a curved surface. The first sidewall 222, the second protruding portion 2262, and the third protruding portion 2282 cooperatively define a chamber 229 to receive the light source 223.

The light sources 223 may not only be adhered to the inner surface of each sidewall 212 facing the first reflective surfaces 225 directly, but also may be fixed on an electric circuit board 24. The electric circuit board 24 with the light source 223 is respectively inserted into the chamber 229 correspondingly. In this embodiment, the light sources 223 are LEDs, and the light sources 223 are fixed on the electric circuit board 24.

In this embodiment, each first sidewall 222 of the light source module 22 is in contact with the protrusion 224 of the adjacent light source module 22. It is noted that the backlight system 20 may further include a prism sheet 26 and a reflective polarizer 27 stacked on the light diffusion plate 25 in that order, for increasing the backlight system 20's optical brightness.

In use, some light rays from the light sources 223 are directly projected onto the light diffusion plate 25, other light rays from the light sources 223 are reflected by the first, second, and third reflective surface 225, 2267, and 2287, before finally projecting into the light diffusion plate 25. It is to be understood that curvature of the first, second and third reflective surfaces 225, 2267 and 2287 may all be adjusted, so as to attain a good optical performance.

Referring to FIG. 2, a backlight system 30 in accordance with a second preferred embodiment is shown. The backlight system 30 is similar in principle to that of the first embodiment, the light source module 32 is same as the light source module 22, except that positions of light source module 32 of the backlight system 30 are different. Each first sidewall 322 of the light source module 32 is in contact with the first sidewall 322 of the adjacent light source module 32, or each protrusion 324 of the light source module 32 is in contact with the protrusion 324 of the adjacent light source module 32.

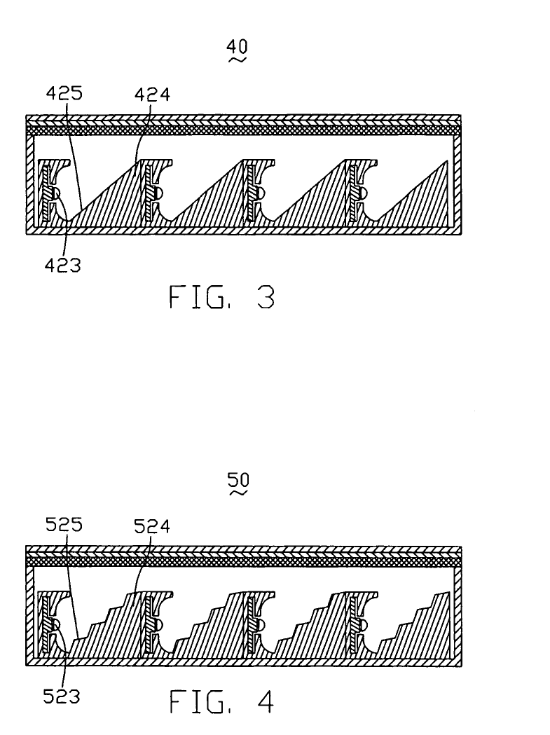

Referring to FIG. 3, a backlight system 40 in accordance with a third preferred embodiment is shown. The backlight system 40 is similar in principle to that of the first embodiment, except that a first reflective surface 425 of a protrusion 424 is a slanted flat surface facing the light sources 423.

Referring to FIG. 4, a backlight system 50 in accordance with a fourth preferred embodiment is shown. The backlight system 50 is similar in principle to that of the first embodiment, except that a first reflective surface 525 of a protrusion 524 is a stepped surface facing the corresponding light source 523.

Referring to FIG. 5, a backlight system 60 in accordance with a fifth preferred embodiment is shown. The backlight system 60 is similar in principle to that of the second embodiment, except that inner surfaces of two opposite sidewalls 622 are slanted towards the base 621. An inclination angle (not labeled) defined by the inner surface of the sidewall 622 with respect to the base 621 is configured to be in a range from about 45 to about 90 degrees.

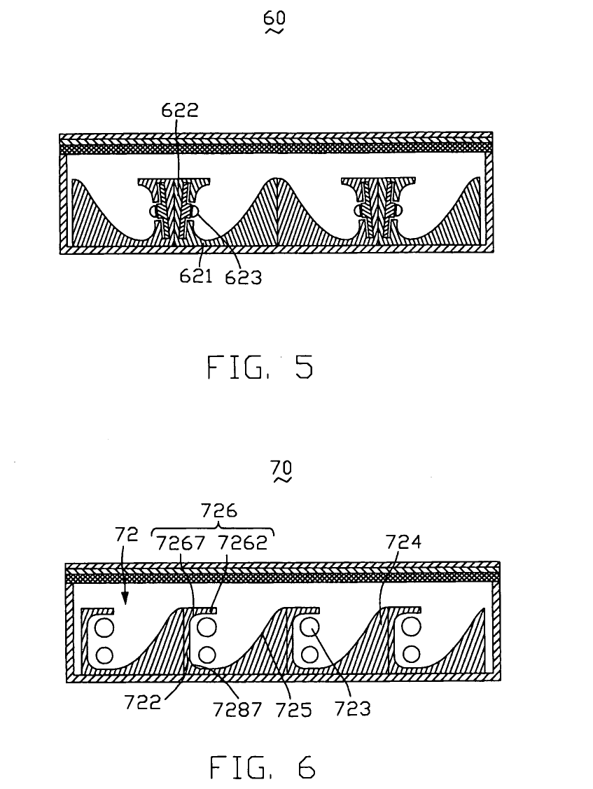

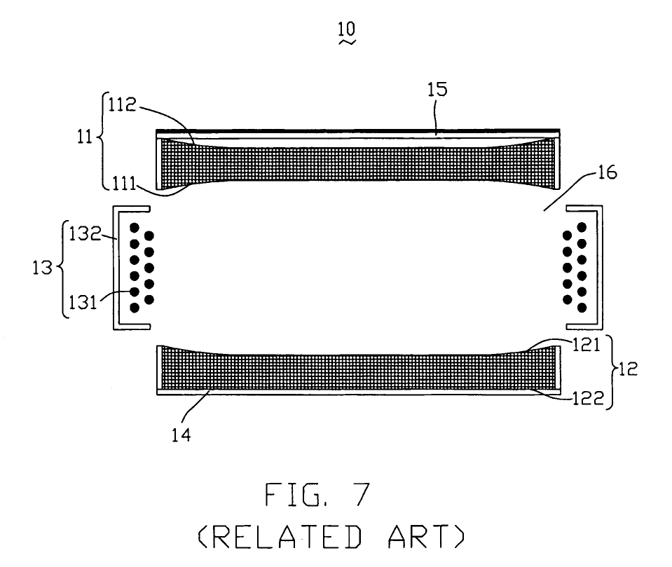

Referring to FIG. 6, a backlight system 70 in accordance with a sixth preferred embodiment is shown. The backlight system 70 is similar in principle to that of the first embodiment, except that light sources 723 employ cold cathode fluorescent lamps (CCFLS). The CCFLS 723 are disposed adjacent and parallel to the sidewall 722. In order to adopt the CCFLS 723, each light source module 72 further includes an upper reflective unit 726 positioned on a top of the corresponding sidewall 722. Each upper reflective unit 726 includes a first protruding portion 7262 extending from a top of sidewall 722 towards an inner area of light source module 72, the first protruding portion 7262 and the sidewall 722 cooperatively forming a second reflective surface 7267 facing the CCFLS 723. The base 721 and the sidewalls 722 cooperatively define a third reflective surface 7287 facing the CCFLS 723.

It is to be understood that the present backlight system may further include a highly reflective film deposited on the reflective surfaces of the protrusion and the upper and bottom reflective units, for improving the light energy utilization rate. More light sources, i.e. LED, may be fixed on the other inner surfaces of the second sidewalls of the frame to increase optical brightness, and help to increase the optical uniformity when adjusting their suitable positions and quantities. It is also to be understood that, the light sources, i.e., LED or CCFLS, may be either fixed to (including in and on) the first sidewall, or adjacent to the first sidewall.

The present backlight system has a good optical uniformity, thin body, lightweight by configuring a reflective surface of the protrusion of each light source module to reflect the light rays from the edge light sources to the light diffusion plate. In addition, the present backlight system has a long server life by avoided using two light guide plates. Furthermore, it should be pointed out that the numbers and sizes of the light source module 22 of the present backlight system are not limited to be illustrated embodiment. The present backlight system employing only one light source module, should be considered to be within the scope of the present invention. As a result, adjusting the size of the backlight system 20 can be done easily and conveniently by assembling or disassembling a number of the light source modules 22 and choosing a suitable size of the light diffusion plate 25.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A backlight system comprising:
a light diffusion plate; and
at least a light source module disposed under the light diffusion plate, the light source module having:
a base;
a first sidewall extending from a longitudinal edge of the base;
a protrusion formed on an edge of the base opposite the first sidewall, the protrusion having a first reflective surface facing the first sidewall; and
at least a light source fixed on or adjacent the sidewall facing the reflective surface of the protrusion in a manner so as to allow light rays from the light source to be reflected at the reflective surface toward the light diffusion plate.

2. The backlight system according to claim 1, wherein the light source module further comprises an upper reflective unit positioned on a top of the first sidewall.

3. The backlight system according to claim 2, wherein the upper reflective unit comprises a first protruding portion extending from a top the first sidewall towards an inner area of the base, a second protruding portion extending from an interior portion of the first protruding portion towards the base, the first protruding portion and the second protruding portion cooperatively forming a second reflective surface facing the first reflective surface of the protrusion.

4. The backlight system according to claim 2, wherein the upper reflective unit comprises a first protruding portion extending from a top the first sidewall towards an inner area of the base, the first protruding portion and the sidewall cooperatively forming a second reflective surface facing the light source.

5. The backlight system according to claim 1, wherein each light source module further comprises a bottom reflective unit each positioned on the base adjacent to the first sidewall, the bottom reflective unit having a third protruding portion extending from the base toward the light diffusion plate, the third protruding portion and the base cooperatively forming a third reflective surface interconnecting the first reflective surface.

6. The backlight system according to claim 1, wherein the first sidewall and the base cooperatively forming a third reflective surface interconnecting the first reflective surface.

7. The backlight system according to claim 1, wherein the protrusion extends out along the opposite edge of the first base, the first reflective surface of the protrusion being selected from one of a curved surface, a flat surface, a stepped surface and a combination thereof.

8. The backlight system according to claim 1, wherein inner surface of the first sidewall of the light source module is slanted to the base, an inclination angle defined by the inner surface of the sidewall with respect to the base being configured to be in a range from about 45 to about 90 degrees.

9. The backlight system according to claim 1, wherein the light source is selected from a group consisting of light emitting diode and cold cathode fluorescent lamp.

10. The backlight system according to claim 9, wherein the light source is a light emitting diode, and the light emitting diode are adhered to the inner surfaces of the two opposite sidewalls.

11. The backlight system according to claim 9, wherein the light source is a light emitting diode, and the light emitting diode is fixed on an electric circuit board, the electric circuit board with the light emitting diode are fixed to the inner surface of the first sidewall.

12. The backlight system according to claim 1, wherein the backlight system comprises a plurality of light source modules, the light source modules being aligned regularly beneath the light diffusion plate, and each first sidewall of the light source module being in contact with the protrusion of the adjacent light source module.

13. The backlight system according to claim 1, wherein the backlight system comprises a plurality of light source modules, the light source modules being aligned regularly under the light diffusion plate, and each first sidewall of the light source module being in contact with first sidewall of the adjacent light source module, or each protrusion of the light source module being in contact with the protrusion of the adjacent light source module.

14. The backlight system according to claim 1, further comprising a frame to receive the light source module, the frame having a rectangular substrate, a plurality of second sidewalls extending from the peripheral of the substrate to define an opening, the light diffusion plate positioned on the opening.

15. The backlight system according to claim 1, further comprising a prism sheet and a reflective polarizer stacked on the light diffusion plate in that order, for increasing optical brightness.

16. The backlight system according to claim 1, further comprising a highly reflective film deposited on the reflective surface of the protrusion.

17. A backlight system comprising:
a supporting substrate;
a light diffusion plate separate from and oriented in a direction substantially parallel to the supporting substrate; and
a plurality of light source modules evenly distributed on a surface of the supporting substrate opposing the light diffusion plate, each of the light source modules including opposing first and second protruding portions and a light source fixed to or adjacent the first protruding portion, the second protruding portion forming a slanted reflective surface structured for reflecting light rays from the light source toward the light diffusion plate.

18. The backlight system of claim 17, wherein the first protruding portion of each light source module contacts the first protruding portion of one adjacent light source module.

19. The backlight system of claim 17, wherein the first protruding portion of each light source module contacts the second protruding portion of one adjacent light source module.
